(19) United States
(12) Patent Application Publication
(10) Pub. No.: US 2025/0365741 A1
(43) Pub. Date: Nov. 27, 2025

(54) TRANSMISSION IN SHARED RESOURCES

(71) Applicant: Samsung Electronics Co., Ltd., Suwon-si (KR)

(72) Inventors: Carmela Cozzo, San Diego, CA (US); Aristides Papasakellariou, Houston, TX (US); Emad Nader Farag, Flanders, NJ (US)

(21) Appl. No.: 19/201,776

(22) Filed: May 7, 2025

Related U.S. Application Data
(60) Provisional application No. 63/650,843, filed on May 22, 2024.

(51) Int. Cl. H04W 72/232

(52) U.S. Cl. CPC H04W 72/232

(57) ABSTRACT

A method for a user equipment is provided. The method includes receiving first information indicating parameters for transmission of a configured-grant physical uplink shared channel (CG-PUSCH) and receiving second information indicating search space sets for receptions of physical downlink control channels (PDCCHs) associated with downlink control information (DCI) formats scheduling a PUSCH transmission. The reception of the PDCCHs is over a duration that starts from a first time offset after the CG-PUSCH transmission. The method further includes receiving third information indicating the first time offset, determining a transmission occasion for the CG-PUSCH based on the parameters, transmitting the CG-PUSCH, and receiving the PDCCHs starting from the first time offset after the CG-PUSCH transmission and over the duration based on the search space sets.

### CROSS-REFERENCE TO RELATED AND CLAIM OF PRIORITY

The present application claims priority under 35 U.S.C. § 119(e) to U.S. Provisional Patent Application No. 63/650,843 filed on May 22, 2024, which is hereby incorporated by reference in its entirety.

### TECHNICAL FIELD

The present disclosure relates generally to wireless communication systems and, more specifically, the present disclosure is related to apparatuses and methods for transmission in shared resources.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to transmission in shared resources.

In one embodiment, a method for a user equipment is provided. The method includes receiving first information indicating parameters for transmission of a configured-grant physical uplink shared channel (CG-PUSCH) and receiving second information indicating search space sets for receptions of physical downlink control channels (PDCCHs) associated with downlink control information (DCI) formats scheduling a PUSCH transmission. The reception of the PDCCHs is over a duration that starts from a first time offset after the CG-PUSCH transmission. The method further includes receiving third information indicating the first time offset, determining a transmission occasion for the CG-PUSCH based on the parameters, transmitting the CG-PUSCH, and receiving the PDCCHs starting from the first time offset after the CG-PUSCH transmission and over the duration based on the search space sets.

In another embodiment, a UE is provided. The UE includes a transceiver configured to receive first information indicating parameters for transmission of a CG-PUSCH, receive second information indicating search space sets for receptions of PDCCHs associated with DCI formats scheduling a PUSCH transmission, and receive third information indicating a first time offset. The reception of the PDCCHs is over a duration that starts from a first time offset after the CG-PUSCH transmission. The UE further includes a processor operably coupled to the transceiver. The processor is configured to determine a transmission occasion for the CG-PUSCH based on the parameters. The transceiver is further configured to transmit the CG-PUSCH and receive the PDCCHs starting from the first time offset after the CG-PUSCH transmission and over the duration based on the search space sets.

In yet another embodiment, a base station is provided. The base station includes a transceiver configured to transmit first information indicating parameters for reception of a CG-PUSCH, transmit second information indicating search space sets for transmissions of PDCCHs associated with DCI formats scheduling a PUSCH reception, and transmit third information indicating a first time offset. The transmission of a PDCCH from the PDCCHs is over a duration that starts from the first time offset after the CG-PUSCH reception. The base station further includes a processor operably coupled to the transceiver. The processor is configured to determine a reception occasion for the CG-PUSCH based on the parameters. The transceiver is further configured to receive the CG-PUSCH and transmit a PDCCH, from the PDCCHs, starting from the first time offset after the CG-PUSCH reception and over the duration based on the search space sets.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency-division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure;

FIG. 9 illustrates a flowchart of an example UE procedure for determining available resources according to embodiments of the present disclosure; and

FIG. 10 illustrates a flowchart of an example UE procedure for determining available resources according to embodiments of the present disclosure.

### DETAILED DESCRIPTION

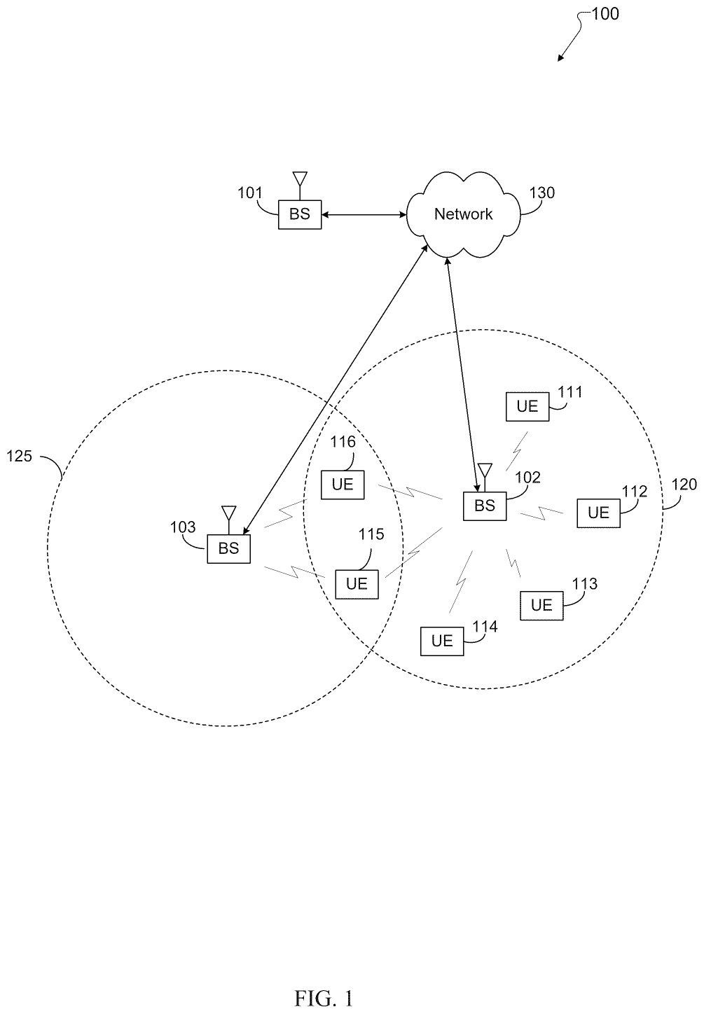

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF1] 3GPP TS 38.211 v18.1.0,“NR; Physical channels and modulation;” [REF2] 3GPP TS 38.212 v18.1.0, “NR; Multiplexing and channel coding;” [REF3] 3GPP TS 38.213 v18.1.0, “NR; Physical layer procedures for control;” [REF4] 3GPP TS 38.214 v18.1.0, “NR; Physical layer procedures for data;” [REF5] 3GPP TS 38.331 v18.0.0, “NR; Radio Resource Control (RRC) protocol specification;” and [REF6] 3GPP TS 38.321 v18.0.0, “NR; Medium Access Control (MAC) protocol specification.”

FIGS. 1-3 below describe various embodiments implemented in wireless communications systems and with the use of orthogonal frequency-division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for transmission in shared resources. In certain embodiments, one or more of the gNBs 101-103 include circuitry, programing, or a combination thereof to provide for transmission in shared resources.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

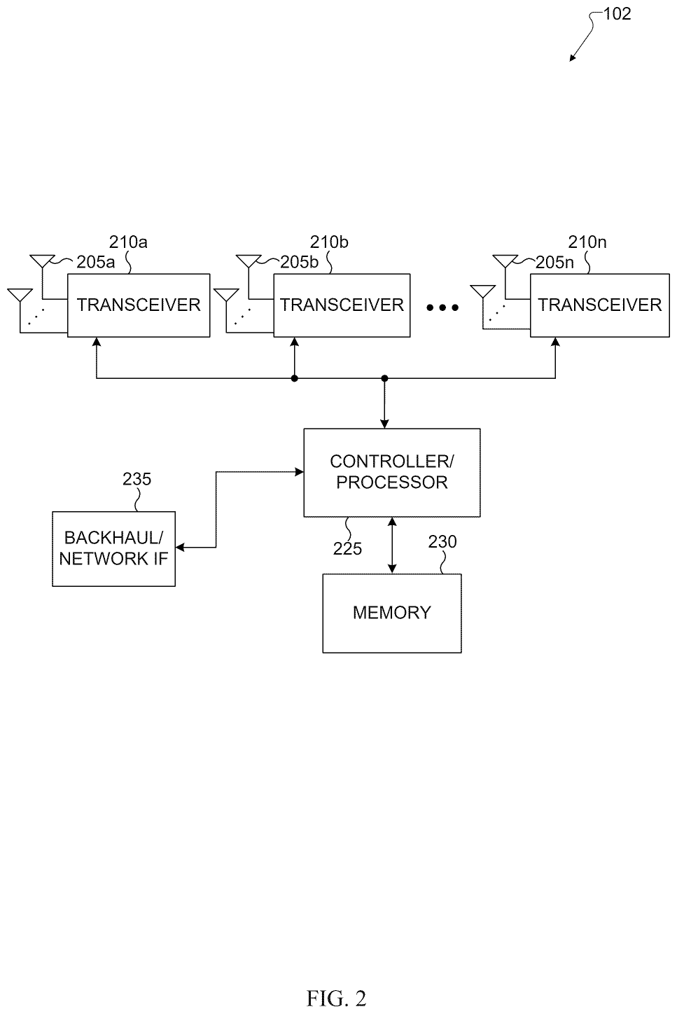

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing support for transmission in shared resources. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

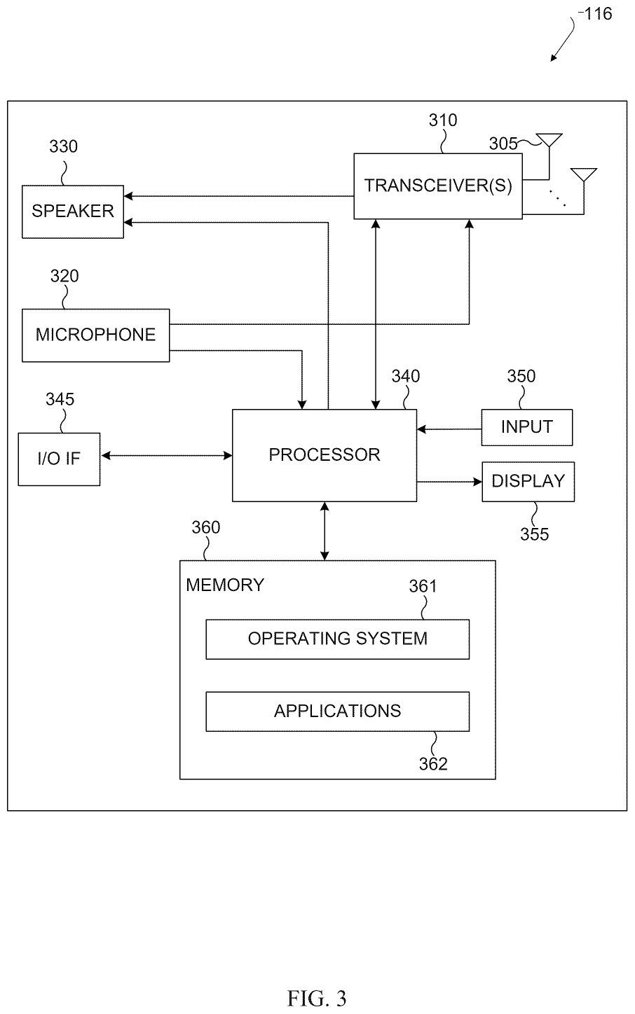

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to for transmission in shared resources as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

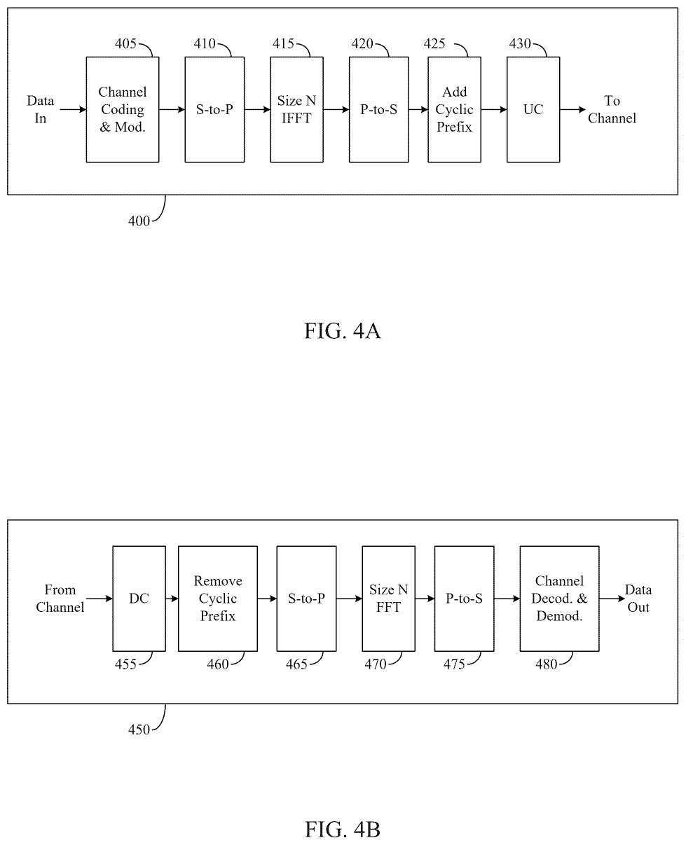

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for support transmission in shared resources as described in embodiments of the present disclosure. In some embodiments, the receive path 450 is configured for support reception in shared resources as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

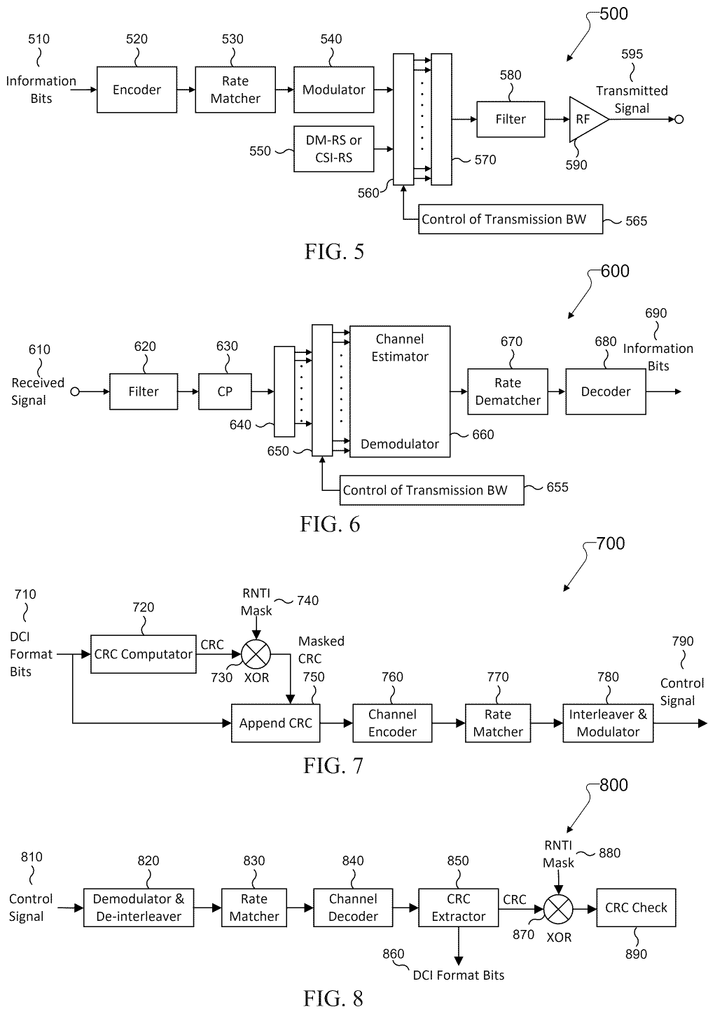

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR(0,0)=0, XOR 0,1)=1, XOR(1,0)=1, XOR(1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

With reference to FIG. 7, an example encoding process for a DCI format according to this disclosure is shown.

With reference to FIG. 8, an example decoding process for a DCI format for use with a UE according to this disclosure is shown.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s <40, an association between the search space set s and a CORESET p, a PDCCH monitoring periodicity of kₛ slots and a PDCCH monitoring offset of 0ₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates

$${M}_{s}^{( L )}$$

per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 v18.0.0, or for DCI formats associated with scheduling broadcast/multicast physical downlink shared channel (PDSCH) receptions, and possibly for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number

$${n}_{s , f}^{μ}$$

in a frame with number n_{f} if

$$( {n}_{f} \cdot {N}_{slot}^{frame , μ} + {n}_{s , f}^{μ} - {o}_{s} ) mod {k}_{s} = 0 .$$

The UE monitors PDCCH candidates for search space set s for Tₛ consecutive slots, starting from slot

$${n}_{s , f}^{μ} ,$$

and does not monitor PDCCH candidates for search space set s for the next kₛ-Tₛ consecutive slots. The UE determines CCEs for monitoring PDCCH according to a search space set based on a search space equation as described in [REF3].

A UE can be configured for operation with carrier aggregation (CA) for PDSCH receptions over multiple cells (DL CA) or for physical uplink shared channel (PUSCH) transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in [REF3] and [REF4].

The present disclosure relates to configured UL shared resources that are shared among multiple users and to mechanisms and signaling for usage of the shared resources. The present disclosure also relates to defining sensing mechanisms for shared resources. The present disclosure also relates to defining signaling associated with an availability of a shared resource. The present disclosure further relates to determining an available resource from configured UL shared for an uplink transmission.

In the following, unless otherwise explicitly noted, providing a parameter value by higher layers includes providing the parameter value by a system information block (SIB), such as a SIB1, or by a common RRC signaling, or by UE-specific RRC signaling.

The following descriptions and embodiments for a UE performing measurements and corresponding measurement reporting equally apply when measurements and reporting by the UE are based on synchronization signal/physical broadcast channel (SS/PBCH) block receptions or CSI-RS receptions.

The following descriptions and embodiments for UL resources shared among one or more UE and used for UL transmissions directly apply or are easily adaptable to SL transmissions and receptions, where resources for SL transmissions and/or SL receptions are shared among one or more SL UE, or to SL and UL transmissions and receptions, where resources for SL transmissions/receptions and UL transmissions are shared among one or more UE.

For UL scheduling, NR supports dynamic scheduling and configured grant (i.e., semi-persistent scheduling). For dynamic scheduling, the network (e.g., the network 130) allocates resources for UL transmission from the UE (e.g., the UE 116) using dynamic signaling based on DCI Format 0_x. When the UE has UL data to transmit, it can send a scheduling request (SR) to the UE, and in response the network schedules an UL transmission using DCI Format 0_x. With dynamic scheduling, resources are allocated on as needed basis however, it suffers from extra latency. For configured grant PUSCH (CG-PUSCH), NR supports Type-1 CG-PUSCH, where resources are allocated and activated by higher layers, and Type-2 CG-PUSCH, where resources are allocated by higher layers, and dynamic signaling, based on a DCI Format, activates/deactivates the resources. CG-PUSCH is introduced to handle transmissions without a grant for control signaling hence reducing PDCCH overhead and latency for semi-persistent traffic as there is no UE scheduling request and corresponding gNB indication of the uplink grant for the transmission. However, CG-PUSCH has limitations. For applications that require a very large number of RBs, the use of CG-PUSCH would imply that a gNB (e.g., the BS 102) would allocate most of the resources in the cell to CG-PUSCH, and this may not even be feasible. UEs configured with CG-PUSCH would benefit from the reduced latency, but UEs not configured with CG-PUSCH would experience additional latency since there would not be enough resources for them to transmit. In addition, if UEs configured with CG-PUSCH do not have data to transmit in some time periods, the configured resources would remain not utilized since these resources may not be used by other UEs, consequently spectrum efficiency and capacity would substantially degrade. In NR the issue of not utilized resources may be alleviated when the UE provides an indication by unused transmission occasions (UTO)-UCI, however, a UE may not always indicate unused transmission occasions. For applications with a large number of users that do not require a large number of RBs to transmit, the use of CG-PUSCH is beneficial unless the traffic is sporadic and/or CG-PUSCH may not be well aligned with the traffic characteristics.

The network may also configure resources to be shared among a group of users. This can be useful when the user traffic is sporadic to reduce latency and control overhead. However, two or more users may attempt to transmit simultaneously in the same resources, leading to collision between the users attempting to transmit. Accordingly, embodiments of the present disclosure recognize that it would be beneficial to provide methods to address collision handling when resources are shared among UEs.

A gNB can configure a set of resources that are shared among UEs, and a UE can directly use the configured resources without verifying whether the resources are utilized by another UE, or the UE can apply a listen-before-talk (LBT) operation and transmit in the resources only after verifying that the resources are not utilized by another UE, hence the resources are not occupied.

In an LBT operation the UE senses the channel before transmitting, and this operation has a latency associated with it and may cause the transmission to be discontinuous. The UE may sense resources from the set of shared resources within one or more configured BWP, in a frequency within the configured BWP and in a time period, e.g. one or more symbols or a slot or a frame, and determine which resources to use for the transmission. The sensing operation that is performed on resources from the set of shared resources can be based on energy detection.

In a full-duplex system the UE can apply a “listen-and-talk” (LAT) operation, and the UE capable of transmitting and receiving in the same time resources can sense and transmit simultaneously. Compared to the LBT operation, the LAT operation has several advantages: the UE does not have to use transmission time for sensing, the UE can do sensing while transmitting so that a next data transmission can happen after a current transmission is complete without waiting for the UE to sense the channel and then transmit.

There are several options for operating a full-duplex wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused or only respective subsets can be active for transmissions and receptions when FD communication is enabled. Instead of using a single carrier, different component carriers (CCs) may be used for receptions and transmissions by the UE. For example, receptions by a UE can occur on a first CC and transmissions by the UE occur on a second CC having a small, including zero, frequency separation from the first CC. Furthermore, a gNB can operate with full-duplex mode and a UE operates in half-duplex mode, such as when the UE can either transmit or receive at a same time, or the UE can also be capable for full-duplex operation. Full-duplex transmission/reception is not limited to gNBs, TRPs, or UEs, but can also be used for other types of wireless nodes such as relay or repeater nodes.

When a UE operates in time division duplexing (TDD) mode and is provided a TDD UL-DL configuration, a slot can be a downlink slot with downlink symbols, or an uplink slot with uplink symbols, or a slot with downlink, and/or flexible symbols, and/or uplink symbols, and each symbol comprises any of the frequency resources in a configured BWP. When a UE operates in duplex mode, a slot can be also configured with sub-bands of a BWP, wherein each symbol of the slot can be either a DL symbol in the DL sub-band or an UL symbol in the UL sub-band. One or more sub-bands for uplink and one or more sub-bands for downlink can occupy different parts of a BWP. For example, a sub-band for uplink can occupy the middle portion of the BWP and the downlink sub-bands can occupy the lower and higher parts of a BWP. Uplink and downlink sub-bands can have different sizes.

FIG. 9 illustrates a flowchart of an example UE procedure 900 for determining available resources according to embodiments of the present disclosure. For example, procedure 900 can be performed by any of the UEs 111-116 of FIG. 1, such as the UE 116. This example is for illustration only and other embodiments can be used without departing from the scope of the present disclosure.

The procedure begins in 910, a U E is configured shared resource for UL transmissions within a configured BWP. In 920, the UE is configured with resource sensing. In 930, the UE is scheduled a CG-PUSCH transmission in resources from the shared resources. In 940, the UE determines an availability of the resources for the CG-PU SCH transmission after resource sensing.

If a UE senses resources from a set of shared resources before transmitting and determines that the resources are occupied, the UE may follow a different procedure based on the type of shared resources configured by the gNB, or on an information associated with the shared resources at the time instance that the UE attempts to use the shared resources, or on the type of traffic, or on a configuration. For example, the UE may attempt to find other resources that are not occupied, or may wait and attempt to access the resources after a configured or indicated time interval, or may wait and use the resources after a configured or indicated time interval.

Whether a UE transmits in a resource from a set of shared resources can be based on an information that is associated with an availability for transmission of the resource. When UEs are provided a configuration for the set of shared resources and one UE uses a resource for transmission, the resource is labeled as unavailable for other UEs. A bitmap can be used to indicate whether or not the resource is available, or the UE receives a dynamic indication from the gNB.

A UE may select a resource for transmission from a set of shared resources without performing resource sensing, and perform resource sensing after a collision has occurred. This operation may be able to achieve a higher spectral efficiency than an LBT operation as it avoids delay and interruptions to the transmission, especially for long transmissions, and also avoids resource consumption for performing sensing. This operation is efficient when traffic load is light so that there are not many collisions. When a collision is detected, the UE stops transmitting and, after a time period, performs sensing to transmit the remaining data.

The present disclosure relates to configured UL shared resources that are shared among multiple users and to mechanisms and signaling for usage of the shared resources. The present disclosure also relates to defining sensing mechanisms for shared resources. The present disclosure also relates to defining signaling associated with an availability of a shared resource. The present disclosure further relates to determining an available resource from configured UL shared for an uplink transmission.

A UE can be provided UL resources by a higher layer parameter and/or by a DCI format indicating a UL grant scheduling a PUSCH transmission, and the UL resources are shared among users. The higher layer parameter providing the UL resources can be a UE-specific parameter or can be a group signaling parameter or a cell-specific parameter. For example, the UE can be provided by group signaling a first set of UL resources that are shared among a first group of UEs and be provided by a UE-specific signaling a second set of UL resources that are UE-specific resources or are shared among a second group of UEs, and the second group of UEs can include same or different UEs included in the first group of UEs.

The UE can also be provided with conditions for using the configured UL shared resources, and such conditions can be provided by cell-specific signaling or by group signaling or by UE-specific signaling. For example, the UE is provided conditions for using the configured UL shared resources by group signaling and additional conditions for using the configured UL shared resources by UE-specific signaling. Conditions for using the configured UL shared resources can include a time period or a maximum time period for the UE to use resources from the UL shared resource, a frequency range of the UL shared resources within a configured BWP, a start symbol or a start slot for the UL transmission, timeline for the UE to perform sensing and start of an UL transmission, a priority for the UE to use the UL shared resources that can be associated with a time interval, or a frequency range, or a combination of time and frequency conditions, or a channel or signal type, for example whether the shared resources would be used to transmit PUSCH or physical uplink control channel (PUCCH) or sounding reference signal (SRS) or scheduling request (SR); channel access mechanisms including whether the UE would perform a sensing of resources before selecting the resources for transmission, the type of sensing that the UE would perform before selecting the resources for transmission; etc.

A UE can also be provided with conditions for using the configured UL shared resources associated with physical channels. In one example, the UE can be configured a set of UL shared resources for CG-PUSCH transmissions, and signals and channels other than CG-PUSCH would use dedicated resources. In one example, the UE can be configured a first set of UL shared resources for CG-PUSCH transmissions, a second set of UL shared resources for SRS transmissions, a third set of UL shared resources for PUCCH transmissions, or a set of UL shared resources for more than one channel. In one example, the UE can be configured with a first set of UL shared resources for scheduling requests and a second set of UL shared resources for UL channels or signals other than SR.

When a UE is configured a set of shared resource for UL transmissions within a configured BWP, the UE can be also configured to perform resource sensing before selecting the resources for transmission.

In one example, the UE is configured to perform resource sensing based on energy detection, and the UE is configured or indicated a number of symbols before a starting symbol of the UL transmission in the UL shared resources. For example, if the UL transmission would start in symbol so of slot n, the number of symbols for sensing can be a last symbol(s) of slot n-1, or can be symbol(s) of slot n before symbol s₀.

In one example, the UE is configured or indicated by a DCI format or by MAC CE to use resources within a frequency range of the configured BWP starting from a time instance and for a time interval, or starting from a symbol (or a symbol of a slot) and for a group of symbols or slots. For example, the UE can use resources in the frequency range in the time interval starting at t₀ and ending at t₀+T_{UL-tx}, or the the UE can use resources in the frequency range in symbols or slots starting at symbol s₀ and ending at s₀+S_{UL-tx}.

In one example, the frequency range can be same as the BWP or can include frequencies from a portion of the BWP. The UE can be configured with UL shared resources that may occupy any frequency within the BWP, and can be additionally configured or indicated by a DCI format or a MAC CE to use only UL shared resources within a portion of the BWP for a configured or indicated time interval.

In one example, after resource sensing, if resources are not occupied the UE starts the UL transmission in the UL shared resources for a number of symbols or slots. The UL transmission in consecutive time resources can be subject to a maximum length that can be configured by a higher layer parameter or indicated by a DCI format or a MAC CE. If the length of UL transmission include a number of consecutive symbols or slots or frames that exceeds the configured or indicated maximum number of consecutive symbol or slots or frames of UL shared resources that the UE can use, the UE transmits in the UL shared resources for the maximum number of consecutive symbols or slots or frames, and for the remaining part of the UL transmission the UE performs resource sensing in a subsequent symbol or slot or frame. The time interval between the last symbol or slot or frame of the UL transmission subject to the maximum length and the symbol or slot or frame where the UE performs resource sensing in order to select resources for transmission of the remaining part of the UL transmission, can be configured by a higher layer parameter or indicated by a DCI format or a MAC CE.

In one example, a UE is configured by a higher layer parameter a configured grant PUSCH transmission in UL shared resources, and the PUSCH transmission is periodic with a period P. When the UE is configured to perform resource sensing, the UE performs resource sensing for each PUSCH transmission, a priority for accessing the UL shared resources may be the same for instances of the periodic PUSCH transmission, or the first instance of the periodic PUSCH transmission is associated with a first priority and other instances of the periodic PUSCH transmission after the first instance of the PUSCH transmission are associated with a second priority, wherein the first priority can have a higher priority of the second priority, or vice versa, and the higher priority can be associated to a smaller priority index. In another example, the UE can be configured to perform resource sensing for the transmission of the first instance of the periodic PUSCH transmission, and other instances of the periodic PUSCH transmission after the first instance of the PUSCH transmission are transmitted without resource sensing prior to the transmission. In another example, the UE can be configured to perform resource sensing for the transmission of an instance of the periodic PUSCH transmission with a sensing periodicity that is larger than the periodicity P of the configured grant PUSCH transmission.

In one example, a UE is scheduled a PUSCH transmission by an UL grant in a DCI format in UL shared resources. In one sub-example, if a configuration for resource sensing before transmission in the UL shared resources only applies to transmissions semi-statically configured, the PUSCH transmission dynamically scheduled is transmitted without resource sensing. When the UE is scheduled PUSCH transmissions of PUSCH repetition or transport block (TB) processing over multiple slots, the PUSCH transmissions are transmitted without resource sensing. In one sub-example, if the configuration for resource sensing before transmission in the UL shared resources applies to transmissions that are scheduled by a DCI format, after sensing: if the scheduled resources, by an UL grant in a DCI format, from the UL shared resources, are available the PUSCH transmission is transmitted, and if the scheduled resources are not available the PUSCH transmission is cancelled. When the UE is scheduled PUSCH transmissions of PUSCH repetition or TB processing over multiple slots, the PUSCH transmissions are transmitted if resources are available, otherwise are cancelled.

In one example, a UE is configured by a higher layer parameter a configured grant PUSCH transmission in UL shared resources, and the PUSCH transmission is scheduled with repetitions. In one sub-example, when the UE is configured to perform resource sensing, the UE performs resource sensing for each PUSCH repetition, and a priority for accessing the UL shared resources may be the same for instances of the periodic PUSCH transmission, or the first instance of the periodic PUSCH transmission is associated with a first priority and other instances of the periodic PUSCH transmission are associated with a second priority, and the first priority is higher than the second priority.

With reference to FIG. 9, an example procedure is shown for a UE to determine resources from configured UL shared resources for an UL transmission according to the disclosure.

A UE may determine whether to transmit in a resource from a set of shared UL resources based on an information that is associated with an availability of the resource. When UEs are provided a configuration for the set of shared resources by a gNB, resources are set as available, and when a resource is used by a first UE for transmission, the resource is set as unavailable for other UEs. The first UE may indicate to the gNB, or to other UEs, that the resource is unavailable. For example, the UE transmits an indication in a DCI format, or sidelink control information (SCI) format, to indicate that the resource is unavailable, and a gNB sets the resource as unavailable. The UE may also indicate that the resource is unavailable by a higher layer parameter. When the UE determines that a resource is available and uses the resource for an UL transmission, for example for a PUSCH transmission, the gNB, after reception of the PUSCH is set to unavailable resources that are used for the PUSCH transmission. In one example, the UE can be scheduled a periodic transmission, and future resources that would be required by the UE to transmit would be set as unavailable for other UEs. In one example, the UE can be scheduled a PUSCH transmission with repetitions, and future resources that would be required by the UE to transmit repetitions would be set as unavailable for other UEs.

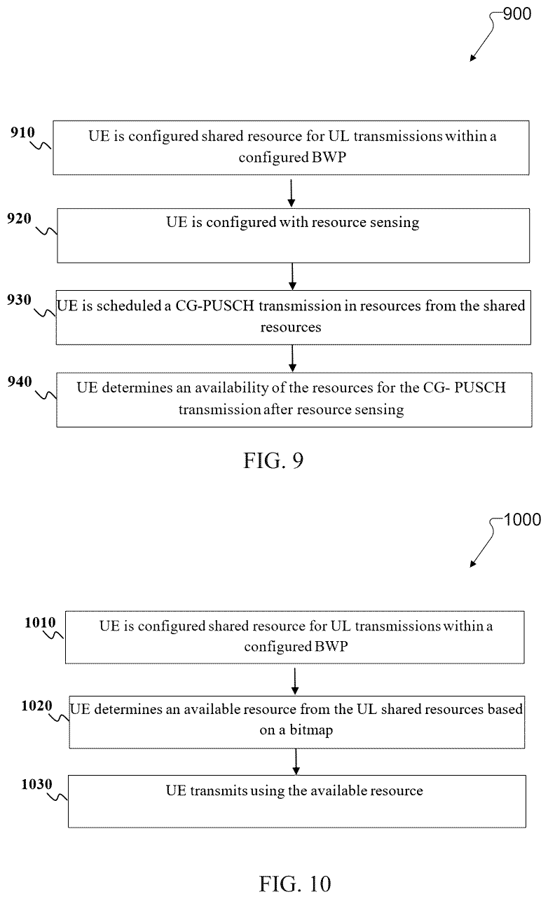

FIG. 10 illustrates a flowchart of an example UE procedure 1000 for determining available resources according to embodiments of the present disclosure. For example, procedure 1000 can be performed by the UE 116 of FIG. 3. This example is for illustration only and other embodiments can be used without departing from the scope of the present disclosure.

The procedure begins in 1010, a UE is configured shared resources for UL transmissions within a configured BWP. In 1020, the UE determines an available resource from the UL shared resources based on a bitmap. In 1030, the UE transmits using the available resource.

A bitmap can be used to indicate whether or not resources from the UL shared resources are available. Thus, the UE configured with UL shared resources is provided a bitmap that indicates the availability of the UL resources. A bit in the bitmap taking value of 1 refers to an available resource, and taking a value of 0 refers to an available resource, or vice versa. The indication of the bitmap can have a symbol, or group of symbols, or slot, or frame granularity.

In addition to the information provided by the bitmap, the UE, prior to using a resource for an UL transmission, performs sensing based on energy detection, or may also request information from the gNB. In one example, the bitmap provides a slot-level information of availability, and a slot is indicated as available when at least a symbol is available, or at least two symbols are available, or at least a number of symbols in the slot are available, or the at least two symbols or the at least number of symbols are consecutive symbols, or the available symbols are after symbol n of the slot and n is equal or larger than 2, or 4, or 7, or a combination according to one or more examples described herein. In another example, the bitmap provides a frame-level information of availability, and a frame is indicated as available when at least a slot, if slot is defined, or a symbol, within the frame is available, or at least two symbols are available, or at least a number of symbols in the frame are available, or the at least two symbols or the at least number of symbols are consecutive symbols, or the available symbols are after symbol n of the frame and n is equal or larger than, or multiple of 2, or 4, or 7, or a combination according to one or more examples described herein. In yet another example, the bitmap provides a symbol-level information of availability, and the UE uses the bitmap to determine whether a symbol is available.

The bitmap can have a length L, wherein L can be an integer number of symbols, slots or frames, and the UE uses the bitmap to determine whether a symbol is available within the length L. If the length M of the UL transmission exceeds the length L, wherein M indicates a number of consecutive symbols, the remaining symbols of the UL transmission, for example M-L symbols are transmitted without verifying whether the UL shared resources are available, or using sensing based on energy detection.

For symbol granularity, in one instance, the bitmap is with length same as the number of symbols in a slot or in frame; in another instance, the bitmap is with length same as the number of symbols in the UL shared resources in a slot or a frame. In yet another instance, the bitmap can be configured by higher layer parameter and be based on Uu RRC configuration or PC5 RRC configuration. In yet another instance, the bitmap can be provided by a MAC CE. In yet another instance, the bitmap can be provided by a SCI format or DCI format.

The bitmap can be associated with a configured BWP or with a frequency range within the BWP, depending on the configuration of the UL shared resources. If in a same BWP, the gNB (e.g., the BS 102) configures more than one set of UL shared resources, wherein the more than one set of UL shared resources can be shared among same or different UEs, some UEs may be configured with more than one set UL shared resources that overlap in time and are separated in frequency. If a UE is configured with CA operation, multiple bitmaps can be used where one bitmap is associated to one carrier or is associated to a set of multiple carriers. The UE is configured with multiple sets of UL shared resources that overlap in frequency and not in time, and one or multiple bitmap to indicate the availability of the UL shared resources of the multiple sets are configured. Whether the UE operates with UL shared resources overlapping in time and/or in frequency in a BWP or across BWPs or across carriers is subject to a UE capability and to a network operation.

With reference to FIG. 10, an example procedure is shown for a UE to determine resources from configured UL shared resources for an UL transmission based on an availability of the UL shared resources provided by a bitmap according to the disclosure.

In a full-duplex system a UE can apply a “listen-and-talk” (LAT) operation, and the UE capable of transmitting and receiving in the same time resources can sense and transmit simultaneously. The UE can be configured with a DL BWP and with a UL BWP, and be configured with UL shared resources in the UL BWP and perform sensing in the DL BWP.

When a UE operates in duplex mode, a slot can be also configured with sub-bands of a BWP, wherein each symbol of the slot can be either a DL symbol in the DL sub-band or an UL symbol in the UL sub-band.

In an embodiment, a UE uses a configured resource for a CG-PUSCH transmission as in operation, wherein the configured resources include a set of RBs and a set of transmission occasions (in time) over a number of symbols as determined, for example, based on a periodicity of transmission occasions after activation or after configuration of a first transmission occasion. To mitigate an overhead associated with a network assigning dedicated resources to each UE for CG-PUSCH transmissions, for example when hundreds of UEs may transmit sporadic traffic on a cell such as for various IoT applications, the network (e.g., the network 130) can assign resources that are partially or fully shared by UEs. Due to an absence of LBT operation, collisions can occur when more than one UEs transmit a CG-PUSCH, or any other channel/signal such as a PUCCH, in shared resources. To facilitate the network to determine an occurrence of such collisions, a UE (e.g., the UE 116) can indicate prior to a CG-PUSCH transmission its intention to transmit a CG-PUSCH. The indication can be provided by a single bit through a PUCCH transmission, similar to an SR transmission using on-off signaling where the UE transmits the PUCCH when it provides the indication and the UE does not transmit the PUCCH when it does not provide the indication. Alternatively, the UE can be configured to transmit the PUCCH at a predetermined time before a subsequent CG-PUSCH transmission and a bit value of 0 can indicate absence of the subsequent CG-PUSCH transmission while a bit value of 1 can indicate presence of the CG-PUSCH transmission. If a first PUCCH transmission providing the indication information for a subsequent CG-PUSCH transmission would overlap in time with a second PUCCH transmission, the UE can multiplex one bit for the indication information together with other uplink control information (UCI) in the second PUCCH transmission or can prioritize the first PUCCH transmission or the second PUCCH transmission and drop the other one. For example, if the second PUCCH transmission is for positive SR information, the UE can prioritize the first PUCCH transmission, and drop the second PUCCH transmission, as the UE can provide a buffer status report (BSR) in a subsequent CG-PUSCH transmission. Alternatively, the UE can prioritize the second PUCCH transmission with the positive SR in order to be scheduled a PUSCH transmission by a DCI format and include a BSR in the PUSCH transmission. For example, if the second PUCCH transmission includes hybrid automatic repeat request acknowledgement (HARQ-ACK) information, the UE can append the indication information at the end of the HARQ-ACK information, at least when the indication information and the HARQ-ACK information have a same priority value, and transmit the second PUCCH. The UE behavior for multiplexing the indication information with other UCI or for prioritizing a PUCCH transmission from PUCCH transmissions that would overlap in time can be indicated by the network, for example by radio resource control signaling, or be defined in the specifications of the system operation.

Because multiple UEs, such as 12-18 UEs, can be orthogonally multiplexed in a single RB for transmitting PUCCHs providing indication for an absence or presence of subsequent respective CG-PUSCH transmissions, an associated overhead is small. For example, 120-180 UEs can be accommodated in 10 RBs for PUCCH transmissions.

Resources for PUCCH transmissions can also be shared among UEs with shared resources for CG-PUSCH transmissions in order to reduce the overhead for the associated PUCCH transmissions, for example to less than 10 RBs in the example herein. For example, if 120 UEs are split in 10 groups of 12 UEs that share same CG-PUSCH resources per group of UEs, i.e. 12 UEs share a first CG-PUSCH resource, another 12 UEs share a second CG-PUSCH resource, and so on, then UEs in a group of UEs can have orthogonal PUCCH resources for transmitting PUCCHs providing indications for respective subsequent CG-PUSCH transmissions as PUCCH transmissions from at least 12 UEs can be orthogonally in a PUCCH resource. First UEs from different groups of UEs can have a same first PUCCH resource, second UEs from different groups of UEs can have a same second PUCCH resource, and so on, while UEs from a same group of UEs have different/orthogonal PUCCH resources. When UEs from different groups of UEs use a same resource to transmit respective PUCCHs indicating a presence of subsequent respective CG-PUSCH transmissions that use different resources, the network can determine that at least one CG-PUSCH will be transmitted and can subsequently determine which of the possible CG-PUSCHs are transmitted for example based on energy detection at the corresponding CG-PUSCH resources. When UEs from a same group use different PUCCH resources to transmit respective PUCCHs indicating a presence of subsequent respective CG-PUSCH transmissions that use same resources, the network may attempt to correctly receive any of the TBs in the colliding CG-PUSCHs and, if that is not possible, the network can schedule a retransmission using means through a DCI format.

In order to support a retransmission of a TB that was first transmitted by a UE in a CG-PUSCH, the UE can be configured search space sets for PDCCH receptions that provide DCI formats scheduling a PUSCH transmission. To reduce power consumption at the UE, the PDCCH receptions by the UE can be confined within a time window after a CG-PUSCH transmission. The time window can start at a first time offset that can be indicated in advance to the UE, for example via RRC signaling, by a serving base station, in order to account for a timeline required by the serving base station to determine incorrect reception of a TB in a CG-PUSCH and then schedule via a DCI format retransmission of the TB by the UE in a PUSCH. The UE can also indicate a capability for a second time offset that is required by the UE to monitor/receive PDCCHs according to the search space sets after the transmission of the CG-PUSCH. Alternatively, the second time offset can be defined in the specifications of the system operation. The first time offset is not smaller than the second time offset. The duration of the time window can be indicated via a corresponding field in each search space set from the search space sets or it can be provided independently of the search space sets via a corresponding RRC parameter. If a value for the duration is provided via a field in each search space set, the UE can expect the values to be same across search space sets or the UE applies the larger of the values indicated by the search space sets. The UE can receive more than one DCI formats scheduling a PUSCH transmission over the duration, for example in order to schedule multiple retransmissions of a TB in case the TB is not correctly received in a first PUSCH scheduled by the DCI format after the CG-PUSCH transmission that provides the TB and a second PUSCH transmission with the TB needs to be scheduled.

The DCI format can be a DCI format scheduling a PUSCH transmission and addressed to a single UE through a corresponding first RNTI such as a cell-radio network temporary identifier (C-RNTI), for example as described in [REF2] v18.0.0. Alternatively, the DCI format can be with a different RNTI than the C-RNTI, such as with a group common (GC)-RNTI, and schedule PUSCH transmissions from one or more UEs wherein a PUSCH transmission includes a TB that a UE initially provided in a CG-PUSCH transmission.

For a DCI format with an RNTI different than a C-RNTI, such as a GC-RNTI, a UE can be indicated a location of a bit that corresponds to the UE in the DCI format. Based on the value of the bit, the UE can determine whether to transmit a PUSCH with the TB that the UE provided in a last CG-PUSCH transmission prior to the detection of the DCI format. For example, a value of ‘0’ indicates to a UE to not transmit the PUSCH while a value of ‘1’ indicates to the UE to transmit the PUSCH.

The last CG-PUSCH transmission can be defined as the latest CG-PUSCH transmission that is prior to the reception of the PDCCH providing the DCI format by a third time offset wherein the third time offset can be indicated to the UE by the serving base station via higher layer signaling or can be defined in the specifications of the system operation. For example, the third time offset can be a number of slots.

The PUSCH transmission scheduled by the DCI format with GC-RNTI mentioned herein can occur at a predetermined slot, such as a first available slot for PUSCH transmission after a processing time for the UE to prepare for the PUSCH transmission, for example such as a processing time defined in [REF3] v18.0.0 or in [REF4] v18.0.0, or can be indicated by the DCI format. In the latter case, additional bits can accompany the bit indicating to the UE whether or not to transmit the PUSCH. A number of additional bits can be indicated to the UE by the serving base station though RRC signaling, for example in the configuration of the fields of the DCI format, or can be defined in the specifications of the system operation. The reference time for the number of slots for the UE to transmit the PUSCH after detecting the DCI format can be the slot of the PDCCH reception that provides the DCI format or the slot of the PDCCH reception that provides the DCI format plus a number of slots corresponding to the processing time required for the UE to prepare the transmission of the PUSCH (after a ceiling operation to obtain an integer number of slots). For example, in the latter case, if the processing time is 1.5 slots, the reference time for the number of slots starts after two slots from the slot n of the PDCCH reception that provides the DCI format, that is from slot n+2. The indication for the slot of the PUSCH transmission can be relative to slots on the serving cell or can be only over slots that are available for the PUSCH transmission, such as slots with sufficient number of consecutive uplink or flexible symbols for the PUSCH transmission.

The DCI format with CG-RNTI mentioned herein can also include a transmit power control (TPC) command for the UE to adjust a power of the PUSCH transmission.

The PUSCH transmission scheduled by the DCI format with CG-RNTI for a TB retransmission mentioned herein can be with same transmission parameters, such as a number or location of RBs in an active UL bandwidth part (BWP) or a number of symbols or a modulation and coding scheme (MCS), as the CG-PUSCH transmission that provides the initial TB transmission. A redundancy version (RV) can also be same or can be different and follow a pattern that is defined in the specifications of the system operations, such as using RV0 for a TB provided by the CG-PUSCH, using RV2 for the TB provided in a first PUSCH scheduled by the DCI format, using RV3 for the TB provided in a second PUSCH scheduled by the DCI format, and using RV3 for the TB provided in a third PUSCH scheduled by the DCI format, and repeating the cycle for additional PUSCHs.

In summary, the embodiment evaluates that a network configures to a UE a PUCCH resource for the UE to transmit a PUCCH before the UE transmits a CG-PUSCH. The PUCCH can be transmitted only when the UE has a subsequent CG-PUSCH transmission and can serve to provide an indication to the network of the subsequent CG-PUSCH transmission. A timeline between the PUCCH transmission and the subsequent CG-PUSCH transmission can be controlled by the network through the configuration of respective resources, including a periodicity of occurrence, or can be explicitly indicated by the network, or can be defined in the specifications of the system operation. The UE can also be mandated to monitor candidate PDCCHs according to one or more configured search space sets after the transmission of a CG-PUSCH in order for the network to schedule by a DCI format in a PDCCH transmission a retransmission of a TB that the UE previously transmitted in a CG-PUSCH, for example when the TB was not correctly received in the CG-PUSCH by the network due to resource collision of CG-PUSCH transmissions by multiple UEs or due to typical reasons causing an incorrect TB reception. A first time offset for the UE to start monitoring/receiving candidate PDCCHs after a transmission of CG-PUSCH can be defined in the specifications of the system operation, or be indicated by the network for example through radio resource control signaling, or be derived from the configuration of associated search space sets. The UE can also indicate a second time offset, associated with a capability for the UE to start monitoring PDCCH after a CG-PUSCH transmission and, in such case, the first time offset is not smaller than the second time offset. The UE can monitor/receive candidate PDCCHs after transmitting a CG-PUSCH within a time window/duration that can be indicated by the network, for example though radio resource control signaling in a SIB or in a UE-specific PDSCH, or can be part of the configuration for the search space sets. The UE then does not need to monitor PDCCH, at least for UE-specific search space sets related to scheduling of PUSCH transmissions, until after the next CG-PUSCH transmission. The DCI format can be a DCI format. Alternatively, the DCI format can be a new DCI format with CRC scrambled by an RNTI different than a C-RNTI for the UE, such as a CG-RNTI, that indicates whether or not the UE transmits a PUSCH that provides a same TB as a last CG-PUSCH transmission, wherein the last CG-PUSCH transmission is defined with respect to a time offset from the slot of the PDCCH reception that provides the DCI format. The new DCI format can additionally include a field indicating a time slot for the PUSCH transmission, relative to a slot of the PDCCH reception with the new DCI format, or additionally include a TPC command for the UE to adjust a power for the PUSCH transmission.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment, the method comprising:
receiving first information indicating parameters for transmission of a configured-grant physical uplink shared channel (CG-PUSCH);
receiving second information indicating search space sets for receptions of physical downlink control channels (PDCCHs) associated with downlink control information (DCI) formats scheduling a PUSCH transmission, wherein the reception of the PDCCHs is over a duration that starts from a first time offset after the CG-PUSCH transmission;
receiving third information indicating the first time offset;
determining a transmission occasion for the CG-PUSCH based on the parameters;
transmitting the CG-PUSCH; and
receiving the PDCCHs starting from the first time offset after the CG-PUSCH transmission and over the duration based on the search space sets.

2. The method of claim 1, wherein:
a value of the duration is indicated by each search space set from the search space sets;
a first search space set of the search space sets indicates a first value for the duration;
a second search space set of the search space sets indicates a second value for the duration; and
the first value is same as the second value.

3. The method of claim 1, further comprising:
receiving fourth information indicating the duration,
wherein the fourth information is not included in the search space sets.

4. The method of claim 1, further comprising:
transmitting an indication for a second time offset,
wherein the first time offset is not smaller than the second time offset.

5. The method of claim 1, further comprising:
receiving fourth information indicating a location of a first bit in a DCI format from the DCI formats;
receiving a PDCCH, from the PDCCHs, that provides the DCI format;
determining a value of the first bit; and
transmitting the PUSCH when the value of the first bit is a predetermined value.

6. The method of claim 5, wherein first resource blocks (RBs), first number of symbols, and first modulation and coding scheme (MCS) for the CG-PUSCH transmission are same as respective second RBs, second number of symbols, and second MCS for the PUSCH transmission.

7. The method of claim 5, further comprising:
determining a number of slots based on a number of second bits in the DCI format,
wherein transmitting the PUSCH further comprises transmitting the PUSCH in a second slot that is after the number of slots from a first slot of the PDCCH reception.

8. A user equipment (UE) comprising:
a transceiver configured to:
receive first information indicating parameters for transmission of a configured-grant physical uplink shared channel (CG-PUSCH);
receive second information indicating search space sets for receptions of physical downlink control channels (PDCCHs) associated with downlink control information (DCI) formats scheduling a PUSCH transmission, wherein the reception of the PDCCHs is over a duration that starts from a first time offset after the CG-PUSCH transmission; and
receive third information indicating the first time offset; and
a processor operably coupled to the transceiver, the processor configured to determine a transmission occasion for the CG-PUSCH based on the parameters,
wherein the transceiver is further configured to:
transmit the CG-PUSCH; and
receive the PDCCHs starting from the first time offset after the CG-PUSCH transmission and over the duration based on the search space sets.

9. The UE of claim 8, wherein:
a value of the duration is indicated by each search space set from the search space sets;
a first search space set of the search space sets indicates a first value for the duration;
a second search space set of the search space sets indicates a second value for the duration; and
the first value is same as the second value.

10. The UE of claim 8, wherein:
the transceiver is further configured to receive fourth information indicating the duration, and
the fourth information is not included in the search space sets.

11. The UE of claim 8, wherein:
the transceiver is further configured to transmit an indication for a second time offset, and
the first time offset is not smaller than the second time offset.

12. The UE of claim 8, wherein:
the transceiver is further configured to:
receive fourth information for a location of a first bit in a DCI format from the DCI formats; and
receive a PDCCH, from the PDCCHs, that provides the DCI format;
the processor is further configured to determine a value of the first bit in the DCI format; and
the transceiver is further configured to transmit the PUSCH when the value of the first bit is a predetermined value.

13. The UE of claim 12, wherein first resource blocks (RBs), first number of symbols, and first modulation and coding scheme (MCS) for the CG-PUSCH transmission are same as respective second RBs, second number of symbols, and second MCS for the PUSCH transmission.

14. The UE of claim 12, wherein:
the processor is further configured to determine a number of slots based on a number of second bits in the DCI format; and
the transceiver is further configured to transmit the PUSCH in a second slot that is after the number of slots from a first slot of the PDCCH reception.

15. A base station comprising:
a transceiver configured to:
transmit first information indicating parameters for reception of a configured-grant physical uplink shared channel (CG-PUSCH);
transmit second information indicating search space sets for transmissions of physical downlink control channels (PDCCHs) associated with downlink control information (DCI) formats scheduling a PUSCH reception, wherein the transmission of a PDCCH from the PDCCHs is over a duration that starts from a first time offset after the CG-PUSCH reception; and
transmit third information indicating the first time offset; and
a processor operably coupled to the transceiver, the processor configured to determine a reception occasion for the CG-PUSCH based on the parameters,
wherein the transceiver is further configured to:
receive the CG-PUSCH; and
transmit a PDCCH, from the PDCCHs, starting from the first time offset after the CG-PUSCH reception and over the duration based on the search space sets.

16. The base station of claim 15, wherein:
a value of the duration is indicated by each search space set from the search space sets;
a first search space set of the search space sets indicates a first value for the duration;
a second search space set of the search space sets indicates a second value for the duration; and
the first value is same as the second value.

17. The base station of claim 15, wherein
the transceiver is further configured to transmit fourth information indicating the duration, and
the fourth information is not included in the search space sets.

18. The base station of claim 15, wherein:
the transceiver is further configured to receive an indication for a second time offset, and
the first time offset is not smaller than the second time offset.

19. The base station of claim 15, wherein:
the transceiver is further configured to transmit fourth information for a location of a first bit in a DCI format from the DCI formats;
the processor is further configured to determine a value of the first bit in the DCI format; and
the transceiver is further configured to:
transmit a PDCCH, from the PDCCHs, that provides the DCI format; and
receive the PUSCH when a value of the first bit is a predetermined value.

20. The base station of claim 19, wherein first resource blocks (RBs), first number of symbols, and first modulation and coding scheme (MCS) for the CG-PUSCH reception are same as respective second RBs, second number of symbols, and second MCS for the PUSCH reception.
